(19) United States
(12) Patent Application Publication
(10) Pub. No.: US 2024/0232798 A1
(43) Pub. Date: Jul. 11, 2024

(54) DYNAMIC PRODUCT AVAILABILITY UPDATING SYSTEMS AND METHODS

(71) Applicant: TARGET BRANDS, INC., Minneapolis, MN (US)

(72) Inventors: Manu PHILIP, Plymouth, MN (US); Craig LENZEN, Minneapolis, MN (US); Venkata S. TIRUMALARAJU, Frisco, TX (US)

(21) Appl. No.: 18/095,970

(22) Filed: Jan. 11, 2023

(51) Int. Cl. G06Q 10/087; G06Q 30/0601

(52) U.S. Cl. CPC G06Q 10/087; G06Q 30/0641

(57) ABSTRACT

Systems and methods for determining product availability based on ingredient stock information are disclosed. An ingredient database is accessed, which contains indications of multiple ingredients utilized for products. A mapping is generated between product recipes for the products and the multiple ingredients from the ingredient database. Current stock information is received for the multiple ingredients, including an indication of an ingredient being out of stock. A product recipe is identified that includes the out-of-stock ingredient, and availability of a product associated with the product recipe is dynamically updated. Updating the availability can include disabling ordering of the product and/or modifying a display of an order screen on a user display.

### FIELD

The described embodiments relate generally to systems and methods for determining product availability to improve ordering functionality for various products.

### BACKGROUND

Businesses of all sizes may allow their customers (e.g., consumers or other businesses) to buy products or services over one or more networks, such as using a web browser or a mobile application, and/or using the Internet or other networks (e.g., local area networks) or combinations of networks (collectively, “online ordering”). For example, a consumer can find a product of interest by visiting a website or ordering application of a retailer directly or by searching among multiple vendors using a search engine, which displays the product's availability and pricing at different vendors. Users can order products and services using various electronic devices, such as desktop computers, laptops, tablet computers, smartphones, and so forth.

Businesses that offer online ordering can enable users to search for or browse specific products and to place orders for products. Upon receiving an order, the business fulfills the order by delivering the product to the user, such as by shipping the product, using a delivery or courier service, making the product available for pickup, serving the product to an in-store customer, or delivering the product electronically (e.g., for download or streaming).

Many products offered via online ordering can comprise combinations of ingredients, such as ingredients comprising raw materials used for making the products or ingredients comprising other products used to make a different product or a combination or bundle of products. When one or more ingredients included in a product are unavailable or out of stock, the business may wish to disable online ordering of the product because the business is unable to fulfill an order for the product. Additionally, businesses may wish to enable online ordering once orders are able to be fulfilled (e.g., because ingredients are in stock).

But businesses face difficult technical challenges related to timely disabling and/or enabling of online product orders. For example, existing technologies make it difficult to determine current stock information for ingredients used in products or estimate future stock information for the ingredients, and existing technologies are unable to use stock information to automatically disable or enable online orders.

### SUMMARY

The following Summary is for illustrative purposes only and does not limit the scope of the technology disclosed in this document.

In one embodiment, a computer-implemented method is disclosed that includes accessing an ingredient database containing indications of multiple ingredients included in products, generating a recipe database comprising a mapping between multiple product recipes and the multiple ingredients, receiving current stock information for the multiple ingredients, and identifying a product recipe including an out-of-stock ingredient indicated in the current stock information. In response to identifying the product recipe that includes the out-of-stock ingredient, ordering of a product associated with the identified product recipe is automatically disabled.

In another embodiment, a system is disclosed including a first computing device associated with an entity offering multiple products, a second computing device associated with a user, and a server. The server accesses an ingredient database containing indications of multiple ingredients included in products. A recipe database is generated that includes a mapping between recipes for the multiple products and the ingredients from the ingredient database. Current stock information for the multiple ingredients is received from the first computing device, including an indication of at least one of the ingredients being out of stock. At least one product recipe is identified that includes the at least one out-of-stock ingredient, and ordering of at least one particular product associated with the identified at least one product recipe is automatically disabled. Additionally, a display of the second computing device is updated to indicate the automatic disabling of the ordering of the at least one particular product.

In yet another embodiment, a method is disclosed that includes accessing a collection of product recipes for multiple products, the product recipes comprising listings of ingredients included in a product, determining stock information for the ingredients, estimating future stock information for the ingredients based on past product sales, projected product sales, or both, determining product availability for the multiple products based on the determined stock information and the estimated future stock information, and automatically updating a display of a user device based on the determined product availability, including enabling or disabling ordering of at least one product disabled based on the determined product availability.

### BRIEF DESCRIPTION OF THE DRAWINGS

FIG. 1 is block diagram illustrating an environment in which a product availability system operates.

FIG. 2 is a display diagram illustrating an interface used by a product availability system, in some implementations.

FIG. 3 is a flow diagram illustrating a process to generate a recipe database.

FIG. 4 is a flow diagram illustrating a process to dynamically update product availability.

FIG. 5 is a block diagram illustrating a simplified view of a computing device that can be used by a product availability system, in some implementations.

### DETAILED DESCRIPTION

Disclosed herein are systems and related methods for dynamically determining product availability and disabling or enabling product ordering based on ingredient stock information (“system” or “product availability system”). As used herein, a “product” can be any good offered by an entity, such as a retail seller, wholesale seller, or other business. A product can be made using one or more ingredients or components, such as raw materials or other components that make up or can be used to generate the product. In some implementations, a base product is a finished product offered by an entity (e.g., for sale to a customer), while a modifier product can be included in and/or added to other products (e.g., a base product), such as to supplement the base product. In these and other implementations, products can also be ingredients of other products. Additionally or alternatively, products can comprise combinations or bundles of other products.

To determine product availability, the product availability system generates one or more product recipes, each product recipe comprising at least a set of ingredients and a quantity of each ingredient, e.g. instructions as to how to make or compile the product. Various ingredient information can be stored, for example, in a database, such as ingredient names/identifiers, ingredient types, ingredient units of measure, ingredient stock information, and so forth. The system generates a recipe database comprising a mapping between multiple product recipes for the multiple products and the multiple ingredients from the ingredient database. The mapping identifies ingredients required to create a product corresponding to each recipe. The system receives current stock information for the multiple ingredients (e.g. ingredient availability at a retailer or other point of sale for the product), which can include current amounts of ingredients available for use and/or indications of one or more ingredients being out of stock or not available for use. Based on at least the mapping and the current stock information, product availability is determined, e.g. the ability of the product to be made based on the stock information and recipe information. The system can automatically disable ordering of a product in response to identifying that a product recipe for the product includes one or more out-of-stock ingredients. That is, the system can prevent users from ordering a product that is unable to be sold or created due to its required ingredients being unavailable at the time the product is ordered. In this manner, the system can provide dynamic updates on an ordering page (e.g. an application) to provide output to users regarding the inventory of a particular multi-ingredient product. Such dynamic information helps to prevent user disappointment and eliminate the need for the retailer to have to send additional notifications or messages to users after order placement indicating that the order cannot be fulfilled. For example, conventional online ordering platforms allow users to order products and then after the order is placed and the retailer begins to assemble the order, when identifying that a required element of the product is missing, the retailer must then generate additional notifications (e.g. emails) to the user indicating that the order cannot be fulfilled.

Additionally, conventional ordering platforms typically track only inventory of completed products (e.g. ready to be sold units, such as pre-shipped goods that are sold as-is rather than requiring modifications, in-store combination with other products or the like). In this manner, existing systems indicate product availability based only on whether the product itself is in stock or out stock. By contrast, the disclosed system can be used to determine product availability based on ingredient stock information. For example, the disclosed system can be used to determine that a product is available even if the product itself is out of stock but sufficient ingredients are available to make additional product units.

Products can be, for example, food and/or beverages. But the teachings of the present disclosure are not limited to implementations related to food or beverages. Generally speaking, the disclosed technology can be used to determine availability and/or enable or disable ordering for any product comprising any ingredients. Likewise, the term “recipe” as used herein can comprise a list of materials or components used to provide or create any product, which may not be consumable (e.g. gift baskets or other arrangements assembled within a retailer and that include multiple sub-products, where the baskets are sold together as a unit and are created on-site). The disclosed technology can be used, for example, in relation to manufacturing, customer service, retail businesses, wholesale businesses, online sellers, and so forth. Additionally, although examples described herein relate to placing and receiving online orders (e.g., orders placed via a mobile application and for in-store pickup), these examples are for illustrative purposes only and are non-limiting. Generally speaking, the disclosed technology can be used in relation to any means of offering/selling products, ordering products, fulfilling product orders, and/or facilitating product orders or sales.

Advantages of the disclosed technology include, without limitation, providing faster and more accurate determinations of product availability and/or improving technologies for receiving online orders, such as orders occurring in real time (e.g., for fulfillment within minutes). For example, the disclosed technology can be used to quickly determine products available for order when a customer is en route to a retail business and the retail business wishes to offer additional products (e.g., food or beverages) that will be available when the customer arrives (e.g., minutes after an order is placed). Additionally, the disclosed technology can more accurately predict future availability of products, such as by estimating future ingredient stocks and adjusting product availability based on these estimations, and eliminate internal processing errors and requirements for multiple notifications by preventing orders on the front end (i.e. before the user places the order) rather than on the back end after the user places the order.

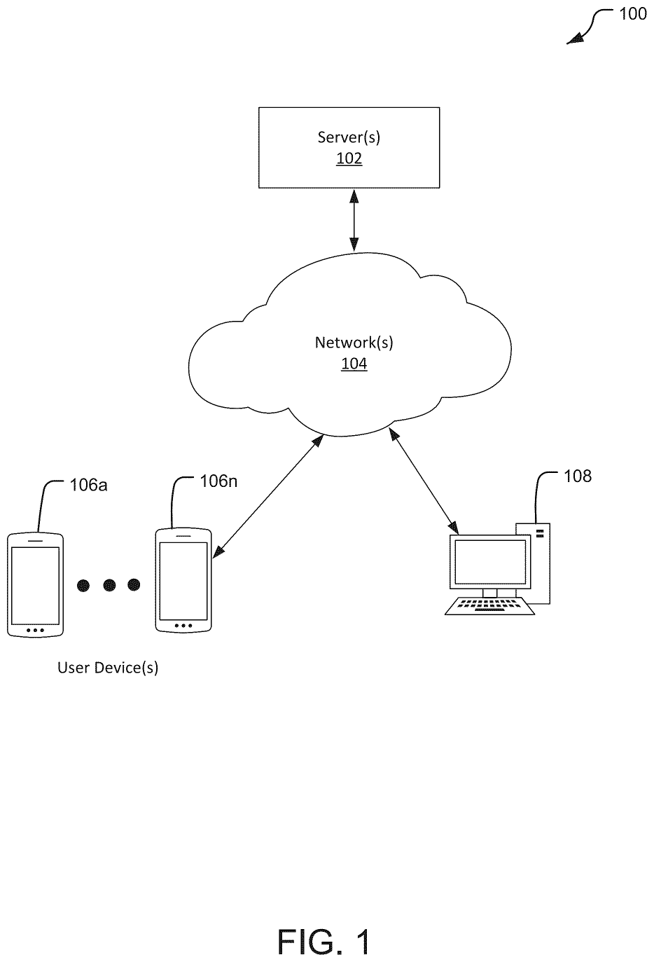

FIG. 1 is block diagram illustrating an environment 100 in which a product availability system operates. The environment 100 includes at least one computing system 108, which can be a computing system used by an entity, such as a retail business. For example, the computing system 108 can comprise one or more on-site computing systems used by the entity for offering products to be ordered using any combination of online ordering and in-person ordering. The computing system 108 can be a point-of-sale system used to conduct transactions between the entity and customers of the entity. Additionally or alternatively, the computing system 108 can include software and/or hardware used to monitor product availability, ingredient stock, and/or other information associated with products offered by the entity. In some implementations, the computing system 108 can comprise multiple computing devices and/or be associated with multiple related entities, such as a first entity comprising a retail store and a second entity comprising a business (e.g., café, quick-service restaurant, or specialty retailer) included within the retail store. In these and other implementations, the computing system 108 can be configured to monitor product availability and/or offer products for the first entity and the second entity, such as to allow the retail store to offer food and/or beverages from the integrated retailer (e.g. the café or quick-service restaurant) to be added to an order from the retail store. Thus, in these and other implementations, the product availability system can be configured to operate across multiple related entities.

The environment 100 also includes one or more user devices 106a-106n associated with users, such as customers of the entity that uses the computing system 108. User devices 106a-106n can be used, for example, to browse and/or search for products offered by the entity and to place orders for available products via a website or an application provided by the entity. User devices 106a-106n can include and/or access one or more software applications for accessing product listings and placing orders, such as entity mobile applications and/or web browsers. User devices 106a-106n can be any computing device capable of accessing product listings and/or placing orders, such as mobile devices, tablets, smartphones, connected and/or smart devices, personal and/or desktop computers, set-top boxes, Internet of things (IoT) devices, and so forth.

The environment 100 also includes one or more server(s) 102, which can comprise one or more cloud servers or other cloud computing resources, application servers, database servers, web servers, and so forth.

The user devices 106a-106n, the computing system 108, and/or the server(s) 102 can communicate via one or more networks 104 included in the environment 100. The one or more networks 104 can include any wired and/or wireless networks and any public or private networks, including but not limited to the Internet, one or more intranets, local area networks (LANs), wide area networks (WANs), telecommunications networks, and so forth. In some implementations, the networks 104 include a network (e.g., a local network) provided at a location of the entity that uses the computing system 108. In some implementations, the networks 104 include the Internet, which is used by the user devices 106a-106n to access the server(s) 102 and/or the computing system 108 (e.g., to access product listings and place orders). Additionally or alternatively, the computing system 108 can use the internet and/or one or more other networks 104 to access the server(s) 102 (e.g., to send and/or receive product information, ingredient information, and so forth).

At least a portion of the product availability system can reside, for example, on the server(s) 102. For example, the server(s) 102 can store and/or provide one or more software applications, databases, and/or other components of the system to perform methods described herein (e.g., to generate mappings, determine product availability, enable and/or disable product orders). In some implementations, the entire product availability system can reside on the server(s) 102. Additionally, or alternatively, at least a portion of the product availability system can reside on the computing system 108. For example, the computing system 108 can provide one or more components of the system to send and/or receive product information, ingredient information, and so forth. Additionally or alternatively, at least a portion of the product availability system can reside on the user devices 106a-106n, such as a mobile application via which product orders are submitted.

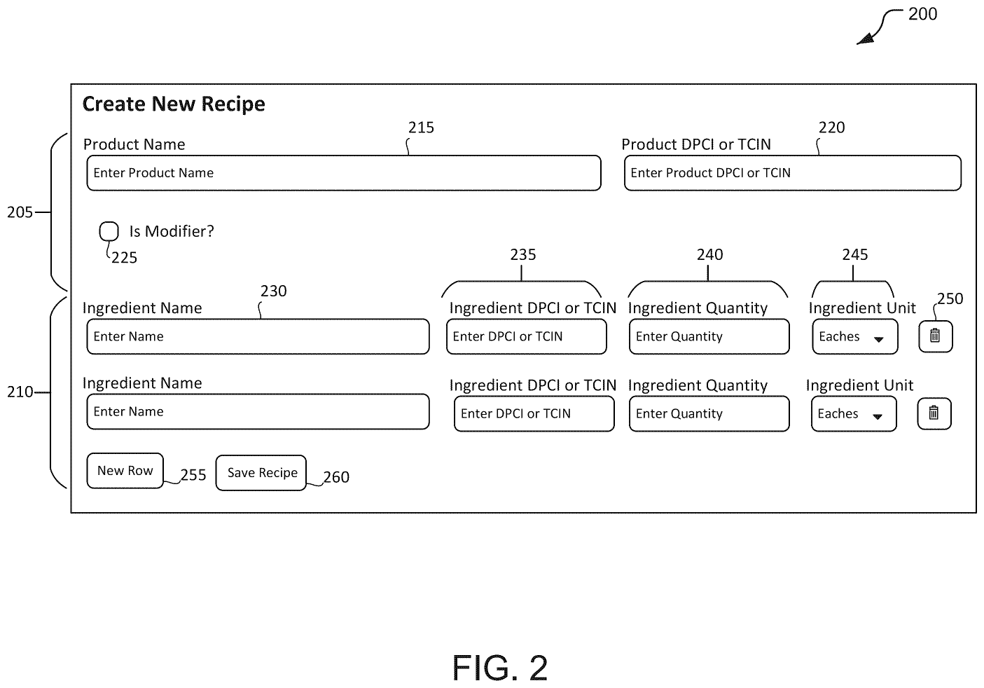

FIG. 2 is a display diagram that illustrates an interface 200 used and/or provided by a product availability system, in some implementations. The interface 200 can be provided by and/or displayed using, for example, the server(s) 102 and/or the computing system 108 of FIG. 1. The interface 200 can be used to generate a new or modified recipe for a product. The interface 200 includes a product information input region 205 and an ingredient information input region 210.

The product information input region 205 includes a product name field 215, a product identifier field 220, and/or a product type field 225. To generate a new or modified product recipe, the product availability system receives a product name via the product name field 215, a product identifier via the product identifier field 220, and/or a product type via the product type field 225. In some implementations, the product name field 215 and the product identifier field 220 are configured to receive inputs comprising strings (e.g. combinations of letters, numbers, and/or other characters). A product identifier can be, for example, a unique identifying number for a product, such as a Department-Class-Item (DPCI) number or a Target.com Item Number (TCIN). The product type field 225 can be a checkbox configured to receive a binary input indicating whether a product associated with the product recipe is a modifier product. A modifier product can be a product that is offered as an add-on to another product and/or included as an ingredient of another product. Thus, the product type field 225 can be used to indicate (e.g., using a checkbox) whether the product is a modifier product. In implementations having at least two product classes, the absence of a check in the product type field 225 can indicate that the product is not a modifier product and/or that the product is of another class, such as a base product offered as a standalone product, and the presence of a check in the product type field 225 can indicate that the product is a modifier product.

The ingredient information input region 210 comprises one or more rows, each row representing an ingredient included in the recipe. A row includes an ingredient name field 230, an ingredient identifier field 235, an ingredient quantity field 240, an ingredient unit field 245, and/or a discard button 250. To add an ingredient to a recipe (and thereby add a row to the ingredient information input region 210 corresponding to the ingredient), the product availability system receives a selection of a new row button 255. In response to receiving the selection of the new row button 255, the product availability system generates and displays an additional row comprising an additional ingredient name field 230, ingredient identifier field 235, ingredient quantity field 240, ingredient unit field 245, and/or discard button 250. To remove an ingredient that is already included in a recipe, the product availability system receives a selection of a corresponding discard button 250 for the ingredient. In response to receiving the selection of the discard button 250, the product availability system removes a corresponding row for the ingredient from the ingredient information input region 210.

When a new ingredient is being added to a recipe, an ingredient name is received via the ingredient name field 230, an ingredient identifier is received via the ingredient identifier field 235, an ingredient quantity is received via the ingredient quantity field 240, and/or an ingredient unit is received via the ingredient unit field 245. For example, a user can input the various information directly and/or the information can be retrieved from other databases or locations. The ingredient name field and the ingredient identifier field can be configured to receive inputs comprising strings, such as combinations of letters and/or numbers. The ingredient quantity field 240 can be configured to receive inputs comprising only numbers. The ingredient unit field 245 can comprise a dropdown menu (not shown) that, when selected, displays a predetermined number of available units of measure. The units of measure can comprise, for example, discrete quantities (e.g., eaches), units of volume (e.g., fluid ounces, cups, pints, quarts, gallons, milliliters, liters), units of weight or mass (e.g., ounces, pounds, tons, grams, kilograms), units of length (e.g., millimeters, centimeters, meters, inches, feet, yards), units of area (e.g., square inches, square centimeters, square feet, square meters), and so forth. Thus, in combination the ingredient quantity and the ingredient units of measure can specify an amount of an ingredient included in a recipe for a certain quantity of products (e.g., per product, per dozen products, per hundred products). Using the new row button 255, any number of rows (and thus any number of ingredients) can be added to a recipe. When a recipe is complete, the product availability system receives a selection of the save recipe button 260, and the recipe is generated and saved (e.g., in a recipe database). Table 1 below illustrates an example of a recipe generated by the product availability system. The illustrated recipe includes a product name and identifier (e.g., “Cappuccino-Medium” and a recipe number) and ingredient information for multiple ingredients comprising an ingredient identifier, an ingredient quantity, and an ingredient unit of measure.

TABLE 1
Recipe No. 47060814 (Cappuccino-Medium)

| product_tcin | ingredient_tcin | ingredient_qty | ingredient_unit |
|---|---|---|---|
| 47060814 | 47064356 | 2 | shots |
| 47060814 | 87376479 | 6.43 | fl. oz. |

Once a recipe is generated and stored by the product availability system (e.g., using the interface 200), the product availability system can monitor availability of corresponding ingredients and use the recipe to determine whether the product is available or unavailable for ordering based on the availability of one or more ingredients or sub-elements. It should be noted that in some instances the recipes may be specific to size, e.g. there may be a separate recipe created for each different size of a particular product that is a separate entry in the database. Alternatively, the system may be configured to scale recipes, such as by including a multiplier against the base recipe to account for different versions.

Although the interface 200 of FIG. 2 depicts certain input fields for purposes of illustration, a person skilled in the art will appreciate that other combinations of input fields or other facilities for receiving inputs can be used. For example, the product availability system can additionally or alternatively be configured to receive voice inputs, gesture inputs, inputs provided via an application programming interface (API), and/or other kinds of inputs provided via the interface 200 or other means of providing inputs. Additionally, more or fewer characteristics of each ingredient can be provided.

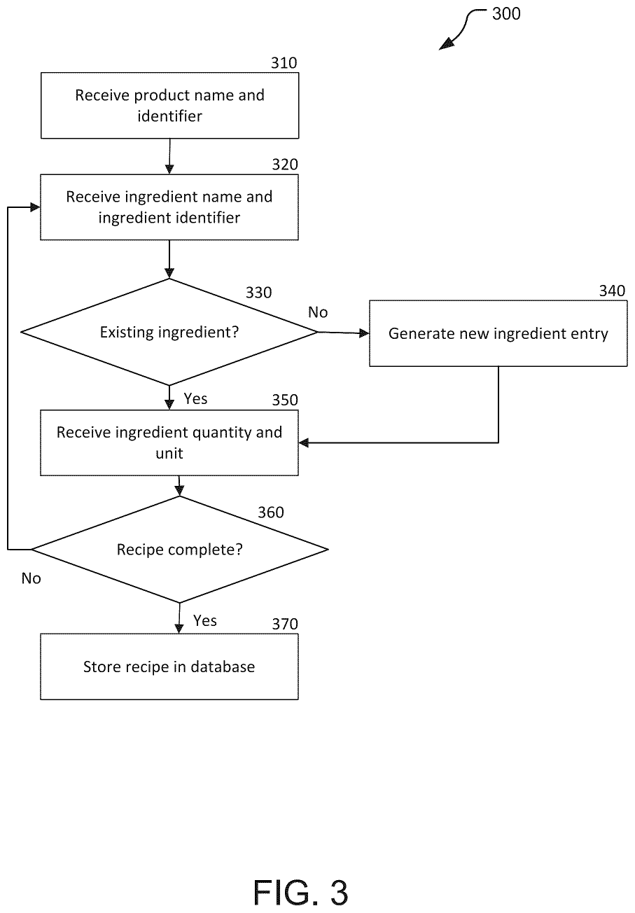

FIG. 3 is a flow diagram illustrating a process 300 to generate one or more recipes for a recipe database. For example, the process 300 can be used to generate a recipe for a product and store the recipe in a database (e.g. a recipe database), and the process 300 can be repeated any number of times to generate any number of database entries. The recipe generated by the process 300 can be for any product and/or combination of products. In some implementations, the recipe can be for a single unit of the product. In some implementations, the recipe can be for multiple product units, such as a batch of products generated using the recipe. In some implementations, the process 300 can be performed using the interface 200 of FIG. 2. In these and other implementations, the process 300 can be performed using server(s) 102 and/or computing system 108 of FIG. 1.

The process 300 begins at block 310, where a product name and/or a product identifier are received. The product name and identifier are provided to identify a new or modified product associated with a recipe being generated by the process 300. The product name and identifier can comprise, for example, character strings. In some implementations, the product identifier can be an existing identifier associated with a product, such as a Department-Class-Item (DPCI) number, Universal Product Code (UPC), a Global Trade Item Number (GTIN), or a Target.com Item Number (TCIN). For example, the product availability system can use existing identifiers to facilitate integration with other systems, such as point-of-sale systems, and the use of existing identifiers can help with determining or estimating future stock information because data from other systems (e.g., sales data) can be easily determined for use by the product availability system.

The process 300 proceeds to block 320, where an ingredient name and an ingredient identifier are received for an ingredient included in the recipe. The ingredient name and identifier can be received from a user (e.g., as manual inputs or using a barcode scanner) or automatically (e.g., retrieved from a database). As described herein, the ingredient can be anything included in and/or used to make the product. Non-limiting examples of ingredients include raw materials used to make a product, such as raw ingredients that are used to make a food product or beverage. Additionally or alternatively, ingredients can be materials used to make a product, such as containers, utensils, decorative items, and so forth. For example, a cup or a beverage sleeve can be an ingredient for a beverage, and a specialized utensil (e.g., a disposable spoon) can be included as an ingredient when it is used to make a product.

Ingredient names and identifiers can comprise, for example, character strings. In some implementations, the ingredient identifier can be an existing identifier associated with a product, such as a Department-Class-Item (DPCI) number or a Target.com Item Number (TCIN).

The process 300 proceeds to decision block 330, where it is determined whether the ingredient is an existing ingredient. For example, a database or other data store of ingredient information can be accessed, and the ingredient name and/or identifier received at block 320 can be used to determine whether an ingredient associated with the name and/or the identifier corresponds to an ingredient that is already represented in the database or other data store (e.g., because the ingredient is already included in the same recipe or a different recipe). A processor can compare the ingredient name or identifier to names or identifiers of existing ingredients included in an ingredient database or ingredients included in one or more product recipes. If a match is determined, then the ingredient is determined to be an existing ingredient.

If the ingredient is not an existing ingredient, then the process 300 proceeds to block 340, where a new ingredient entry is generated. For example, a processor can generate a new entry in the database or other data store using the ingredient name and identifier received at block 320. Table 2 below illustrates example ingredient entries generated by the product availability system. Each entry includes ingredient identifiers (e.g., TCIN and DPCI), ingredient types (e.g., ingredient or product), and ingredient names or descriptions. As described herein, products can be included as ingredients in other products (e.g., a cappuccino is a product that could be included in another product comprising a bundle of products).

TABLE 2

| tcin | dpci | type | description |
|---|---|---|---|
| 47060814 | 254-16-0022 | Product | Cappuccino-Medium |
| 47064356 | 254-16-0001 | Ingredient | Espresso |
| 87376479 | 254-18-0099 | Ingredient | 2% Milk |

The process 300 proceeds to block 350, either after it is determined at block 330 that the ingredient is an existing ingredient or after generating the new ingredient entry at block 340. At block 350, an ingredient quantity and/or an ingredient unit of measure are received. The ingredient quantity and unit of measure can be received from a user (e.g., as a manual input) or automatically (e.g., retrieved from a database or file). If the ingredient is an existing ingredient, then the ingredient unit of measure can be determined automatically (e.g., based on a database entry for the existing ingredient, which can specify a default unit of measure). Together, the ingredient quantity and the ingredient unit of measure specify the amount of the ingredient to include in the recipe.

The process 300 proceeds to decision block 360, where it is determined (e.g., by a processor) whether the recipe is complete. For example, if a selection of the new row button 255 of FIG. 2 is received, then a processor detects the selection of the new row button and determines that the recipe is not complete. Alternatively, if the processor detects selection of a command to save or generate the recipe, then the processor determines that the recipe is complete. A recipe can be determined to be complete, for example, in response to receiving a selection of the save recipe button 260 of FIG. 2.

If it is determined at decision block 360 that the recipe is not complete, then the process 300 proceeds to block 320, where an ingredient name and/or identifier are received for an additional ingredient to include in the recipe.

If at block 360 it is determined that the recipe is complete, then the process 300 proceeds to block 370, where the recipe is generated and stored (e.g., in a recipe database or other data store).

The recipe can be generated and stored in various ways. For example, the recipe can be stored as a table, spreadsheet, or delimited file containing the product name and identifier, each ingredient name and identifier, and each ingredient quantity and unit of measure.

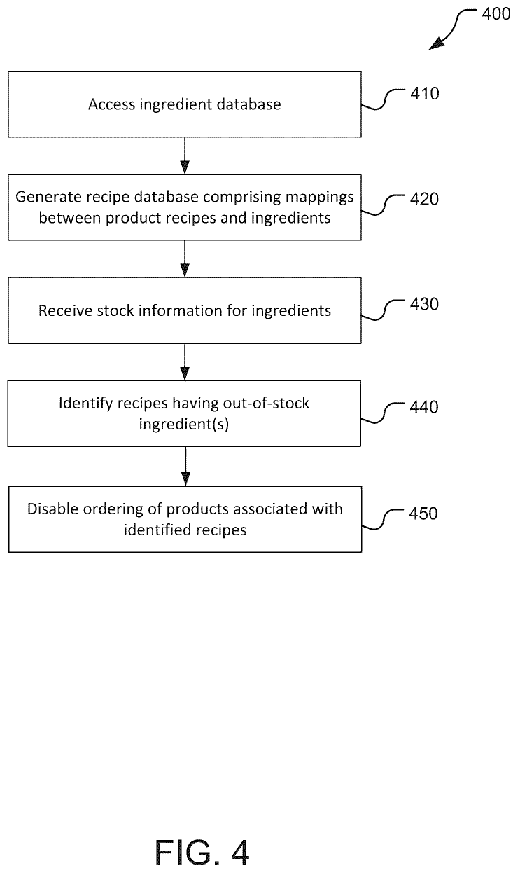

FIG. 4 is a flow diagram illustrating a process 400 to dynamically update product availability. For example, the process 400 can be used to automatically disable and/or enable product orders based on current ingredient stock information. The process 400 can be performed, for example, using the server(s) 102 and/or the computing system 108 of FIG. 1, and the product availability can be used to update ordering via the user devices 106a-106n of FIG. 1, such as by updating a display and/or an interface displayed on one or more of user devices 106a-106n. Additionally or alternatively, product availability can be updated based on product recipes generated using the interface 200 of FIG. 2 and/or the process 300 of FIG. 3.

The process 400 begins at block 410, an ingredient database is accessed. For example, a processor can query the database automatically or in response to a user input to retrieve ingredient information or to determine product availability. The ingredient database can contain indications of multiple ingredients utilized for multiple products. In some implementations, the ingredients indicated in the ingredient database can be associated with an ingredient class or type, such as base ingredients (e.g., ingredients included in a base product) and add-on ingredients (e.g., ingredients included in a modifier product).

The process 400 proceeds to block 420, where a recipe database is generated. The recipe database comprises one or more product recipes (e.g., recipes generated using the process 300 of FIG. 3) and/or a mapping between multiple product recipes for the multiple products and the multiple ingredients from the ingredient database. The mapping identifies corresponding ingredients for each product recipe. The mapping can be, for example, a lookup table (LUT) that correlates product recipes to corresponding ingredients in the ingredient database. In this manner, generating the recipe database can include generating, by a processor, the lookup table that correlates the product recipes (e.g., ingredient names/identifiers and ingredient quantities/units of measure) to ingredients in the ingredient database. In some implementations, the products can comprise food products, beverages, or both food products and beverages. The recipe database can include, for example, ingredient units of measure and ingredient quantities for the recipes.

In some implementations, the recipe database includes multiple classes or types of recipes. For example, recipe types can include modifier recipes for modifier products that are offered as an add-on to a base product. The recipe types can also include base recipes for base products (e.g., standalone products offered for sale, as distinct from the modifier products).

The process 400 proceeds to block 430, where stock information is received for at least some of the multiple ingredients indicated in the ingredient database. The stock information can be current stock information, such as a currently-available amount (e.g., quantity and unit of measure) of the ingredients. In some implementations, the stock information is provided in real time (e.g., to indicate stock information at a current time with an accuracy of seconds or minutes). The stock information can include an indication of at least one ingredient being out of stock (i.e., a current stock amount of zero or near zero).

The stock information can be received in various ways. In some implementations, the stock information is received via a computing system of an entity that provides the multiple products (e.g., a retail store). For example, a user of a computing system of the entity can input stock information to the computing system to be received by the product availability system. In these and other implementations, the stock information can be received in real time and/or at predetermined intervals (e.g., hourly, daily, weekly). Additionally or alternatively, at least a portion of the stock information can be determined automatically, such as by monitoring stock information (e.g., using sensors) and/or automatically determining or estimating current stock information based on previous stock information and actual, estimated, and/or projected product sales during one or more time periods.

In some implementations the stock information can be for ingredients stocked by different entities and/or stored in different physical locations. For example, a first ingredient might be stored in a warehouse, while a second ingredient can be stored on premises (e.g., within a retail store). In another example, a first ingredient might be en route for delivery to a physical location, while a second ingredient is already in stock. In a further example, a first entity (e.g., a café, quick-service restaurant, or specialty store) can have a physical location inside of a physical location of a second entity (e.g., a retail business), and the stock information can be for a first ingredient stocked by the first entity and a second ingredient stocked by the second entity. In these and other implementations, the product availability system can centrally access stock information for each of the different entities and/or each of the physical locations (e.g., in real time).

The process 400 proceeds to block 440, where one or more recipes from the recipe database are identified as using or having one or more ingredients that are indicated as being out of stock in the stock information received at block 430 and based on the mapping generated and/or accessed at block 420.

The process 400 proceeds to block 450, where ordering of the products corresponding to the one or more recipes identified at block 440 is disabled. In other words, based on or in response to determining that a recipe for a product includes an out-of-stock ingredient, the product availability system causes the product to be unavailable for ordering (e.g., for online ordering via a website and/or an app).

Although the depicted example describes disabling product orders based on out-of-stock ingredients, the process 400 can additionally or alternatively include adjusting or modifying product availability or product orders in other ways. For example, in some implementations, the process 400 can include enabling (or re-enabling) product orders (e.g., at block 450) for a product when the stock information (e.g., received at block 430) indicates that a particular ingredient is in stock beyond a threshold amount and/or after the particular ingredient was previously identified as being out of stock.

In some implementations, adjusting or modifying product availability can include updating an interface of a mobile-ordering application (e.g., in real time) to indicate product availability and/or enable or disable product ordering. For example, an entity can provide a website or a mobile application that includes the interface for submitting product orders. As product entries are generated and rendered for display in the interface, the product availability system determines if products are impacted by any ingredients being unavailable. If a product is determined to be unavailable, the product availability system will change a display characteristic of a corresponding product listing. For example, a product listing for an unavailable product can be grayed out in the interface or an “add to cart” icon can be disabled or removed for the item, helping to both alert a user to the out of stock state of the product, as well as prevent the system from receiving orders that cannot be fulfilled and need to be canceled or modified.

In a further example, an entity that offers the products can provide an interface for receiving product orders in relation to an in-store pickup feature. A user can indicate (e.g., through the interface) that the user is en route to the store to pick up an order, and the interface can display products that will be available when the user arrives. In these and other implementations, for example, the entity can be a retail store having an on-premises café or quick-service restaurant, and the product availability system can be used to dynamically update the interface to indicate products from the café or quick-service restaurant that can be added to an in-store pickup order of the retail store (e.g., “I see you are en route to the store. We can offer the following beverages to be added to your order, and they will be ready when you arrive . . . ”).

Additionally, adjusting or modifying product availability can include updating an interface of a mobile-ordering application to indicate product availability for an online ordering or delivery service, such as a food delivery service. The online ordering or delivery service can be offered by the entity that offers the products or as a third-party service. For example, the process 400 can be used by a third-party delivery service to indicate, via a mobile-ordering application, products available for ordering.

In implementations including multiple product types or classes, adjusting and/or modifying product availability can include adjusting product availability for the different product types or classes, such as disabling and/or enabling ordering of both a modifier product and a base product.

In some implementations, adjusting or modifying product availability can include identifying an alternative product recipe that is similar to the one or more recipes identified at block 440 and enabling ordering of an alternative product associated with the alternative product recipe, such as an alternative product recipe that does not include the out-of-stock ingredient. For example, the product availability system can identify an alternative product recipe by estimating or determining a similarity between the alternative product and a product that includes the out-of-stock ingredient. The similarity can be estimated, for example, based on the presence of similar ingredients in the alternative product recipe and an identified product recipe. Upon determining that the products are sufficiently similar (e.g., beyond a threshold similarity score), the product availability system can automatically enable ordering of the alternative product (e.g., as a substitute for the identified product).

In some implementations, the process 400 can include estimating ingredient stock information, such as current or future stock information, based on product sales during a time period. Product availability can then be determined based on the estimated ingredient stock information. For example, to estimate future stock information, the product availability system can modify current stock information (e.g., received at block 430) to reduce stock of one or more ingredients based on a number of products sold during a time period between receipt of the current stock information and a current time (e.g., to reflect a reduction in ingredient stock from products sold since the current stock information was received). Additionally or alternatively, the product availability system can estimate future stock by estimating future product sales during a time period between a current time and a future time and reducing the current stock information based on the estimated future product sales (e.g., to reflect a reduction in ingredient stock from estimated future sales of products containing certain ingredients). In these and other implementations, the estimated future ingredient stock can be used to modify or adjust product availability (e.g., disable product sales at a future time based on estimating that one or more ingredients used for a product will run out at the future time).

In some implementations, the process 400 can be performed using a system comprising one or more computing devices or computing systems. For example, the stock information can be received via a first computing device on a first network (e.g., a point-of-sale system and/or an entity computing system used by an entity that offers the products), the one or more recipes from the recipe database can be identified using a server (e.g. a cloud server), and product orders can be disabled and/or enabled (e.g., by the server) on a display of a second computing device on a second network (e.g., a customer device in communication with the server and/or the first computing device via the Internet).

Although the processes 300 and 400 are illustrated as including certain operations performed in an illustrated order, the processes 300 and 400 can be modified according to the teachings of the present disclosure. For example, operations can be added to or removed from the processes 300 and 400. Additionally or alternatively, the operations can be performed in any order, including performing one or more operations in parallel.

Using the product availability system and the methods (e.g., processes 300 and 400) disclosed herein, a café ordering application can be enhanced. For example, the system will automatically update product availability based on inputs from a point-of-sale device within the café indicating currently available ingredients, such as by analyzing all products to identify products impacted by one or more ingredients being out of stock. Once a product has been identified, the system can update a product page for the product on an application to indicate that the identified product is not available due to the one or more out-of-stock ingredients. A user of the application can then be informed (e.g., in real time) of the product being unavailable, which will facilitate the user's placement of an order and improve customer satisfaction because the user can more readily determine products that are currently available for ordering.

The product availability system can be used, for example, to determine product availability quickly and accurately for entities offering a large number of products (e.g., hundreds or thousands of products) and/or a similarly large number of ingredients. In these and other implementations, the product availability system can determine product availability for multiple products in parallel and/or in real time (e.g., in second or minutes), rather than requiring a manual or ad hoc analysis of ingredient stock in comparison to product recipes. Additionally, the product availability system can comprehensively analyze all or substantially all products offered by an entity in a way that cannot be performed manually because modern businesses may offer too many products and/or use too many ingredients to be tracked manually while also maintaining customer satisfaction.

In an example implementation, the product availability system can be used to automatically disable product orders for all items on the menu of a café or restaurant including an out-of-stock ingredient. This can be especially useful for cafés or restaurants with large menus (e.g., hundreds of items) or for ingredients that are included a similarly large number of recipes (e.g., onions or milk). Rather than having to manually identify all recipes that include these common ingredients, which could take hours of manual effort, the disclosed system can automatically identify these recipes and disable ordering of the corresponding products in seconds. Additionally, current systems may be substantially reactive, such as by only identifying that ingredients are unavailable to make a product upon receiving an order for the product, whereas the disclosed technology can proactively disable product orders to prevent users from ordering products when insufficient ingredients are available to make the products.

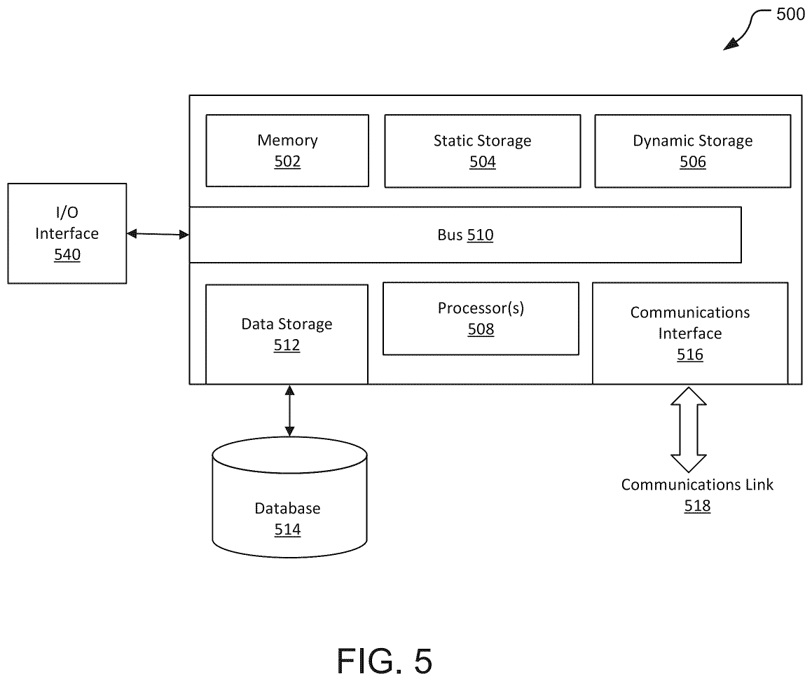

FIG. 5 is a block diagram that illustrates a simplified block diagram of an example computing system 500 that can be used to implement various embodiments in the examples described herein. For example, the server(s) 102, user devices 106a-106n, and/or the computing system 108 of FIG. 1 can include or be implemented by the computing system 500. This disclosure contemplates any suitable number of computing systems 500. For example, the a computing system 500 can be a server, a desktop computing system, a mainframe, a mesh of computing systems, a laptop or notebook computing system, a tablet computing system, a mobile device (e.g., a smartphone) an embedded computer system, a system-on-chip, a single-board computing system, or a combination of one or more of these. Where appropriate, the computing system 500 can include one or more computing systems; be unitary or distributed; span multiple locations; span multiple locations; span multiple machines; span multiple data centers; or reside in a cloud, which may include one or more cloud components in one or more networks.

Computing system 500 includes one or more communication structures, such as a bus 510 (e.g., an address bus and a data bus) or other communication mechanism for communicating information, which interconnects subsystems and devices, such as processor(s) 508, memory 502 (e.g., RAM), static storage 504 (e.g., ROM), dynamic storage 506 (e.g., magnetic or optical), communications interface 516 (e.g., modem, Ethernet card, a network interface controller (NIC) or network adapter for communicating with an Ethernet or other wire-based network, a wireless NIC (WNIC) or wireless adapter for communicating with a wireless network, such as a WI-FI network), input/output (I/O) interface 540 (e.g., keyboard, keypad, mouse, microphone). In particular embodiments, the computing system 500 can include one or more of any such components.

In particular embodiments, the processing element or processor(s) 508 includes hardware for executing instructions, such as instructions included in a computer program. The processor(s) 508 circuitry includes circuitry for performing various processing functions, such as executing specific software for perform specific calculations or tasks. In particular embodiments, I/O interface 540 includes hardware, software, or both, providing one or more interfaces for communication between computing system 500 and one or more I/O devices. Computing system 500 can include one or more of these I/O devices, where appropriate. One or more of these I/O devices may enable communication between a person and computing system 500.

In particular embodiments, communications interface 516 includes hardware, software, or both providing one or more interfaces for communication (such as, for example, packet-based communication) between computing system 500 and one or more other computer systems or one or more networks, e.g., network(s) 104. One or more memory buses (which may each include an address bus and a data bus) may couple processor(s) 508 to memory 502. Bus 510 can include one or more memory buses, as described below. In particular embodiments, one or more memory management units (MMUs) reside between processor(s) 508 and memory 502 and facilitate accesses to memory 502 requested by processor(s) 508. In particular embodiments, bus 510 includes hardware, software, or both coupling components of computing system 500 to each other.

According to particular embodiments, computing system 500 performs specific operations by processor(s) 508 executing one or more sequences of one or more instructions contained in memory 502. For example, instructions to perform the methods described herein can be contained in memory 502 and can be executed by the processor(s) 508. Such instructions can be read into memory 502 from another computer-readable/usable medium, such as static storage 504 or dynamic storage 506. In these and other embodiments, hard-wired circuitry can be used in place of or in combination with software instructions. Thus, particular embodiments are not limited to any specific combination of hardware circuitry and/or software. In various embodiments, the term “logic” means any combination of software or hardware that is used to implement all or part of particular embodiments disclosed herein.

The term “computer-readable medium” or “computer-usable medium” as used herein refers to any medium that participates in providing instructions to processor(s) 508 for execution. Such a medium can take many forms, including but not limited to, non-volatile media and volatile media. Non-volatile media includes, for example, optical or magnetic disks, such as static storage 504 or dynamic storage 506. Volatile media includes dynamic memory, such as memory 502. In some embodiments, a computer-readable or computer-usable medium does not include transitory signals.

Computing system 500 can transmit and receive messages, data, and instructions, including program, e.g., application code, through communications link 518 and communications interface 516. Received program code can be executed by processor(s) 508 as it is received, and/or stored in static storage 504 or dynamic storage 506, or other storage for later execution. A database 514 can be used to store data accessible by the computing system 500 via data interface 512. In various examples, communications link 518 can communicate with, for example, the user devices 106a-106n, the server(s) 102, and/or the computing system 108 of FIG. 1.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations can be performed in any order, unless explicitly claimed otherwise or unless a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology can be employed in special-purpose devices independent of a personal computer.

The above specification, examples and data provide a complete description of the structure and use of example embodiments as defined in the claims. Although various example embodiments are described above, other embodiments using different combinations of elements and structures disclosed herein are contemplated, as other implementations can be determined through ordinary skill based upon the teachings of the present disclosure. It is intended that all matter contained in the above description and shown in the accompanying drawings shall be interpreted as illustrative only of particular embodiments and not limiting. Changes in detail or structure can be made without departing from the basic elements as defined in the following claims.

What is claimed is:

1. A computer-implemented method of automatically disabling product orders based on current ingredient stock information, the method comprising:
accessing an ingredient database containing indications of multiple ingredients utilized for multiple products;
generating a recipe database that includes a mapping between multiple product recipes for the multiple products and the multiple ingredients from the ingredient database, wherein the mapping identifies for each of the multiple product recipes corresponding ingredients of the multiple ingredients required to create a respective product of the multiple products;
receiving current stock information for the multiple ingredients, wherein the current stock information includes an indication of at least one of the multiple ingredients being out of stock;
identifying, using the mapping and the current stock information, at least one product recipe of the multiple product recipes that includes the at least one out-of-stock ingredient; and
in response to identifying the at least one product recipe that includes the at least one out-of-stock ingredient, automatically disabling ordering of at least one particular product associated with the identified at least one product recipe.

2. The computer-implemented method of claim 1, wherein the multiple products comprise food products, beverages, or both food products and beverages.

3. The computer-implemented method of claim 1, wherein the recipe database includes, for at least some of the multiple product recipes, ingredient units of measure and ingredient quantities.

4. The computer-implemented method of claim 1, wherein the multiple product recipes include a first class of recipes comprising base product recipes for base products and a second class of recipes comprising modifier recipes for modifier products, wherein the modifier products are offered as an add-on to the base products.

5. The computer-implemented method of claim 4, wherein automatically disabling ordering of the at least one particular product includes disabling both a modifier product and a base product.

6. The computer-implemented method of claim 1, wherein the multiple ingredients include base ingredients and add-on ingredients.

7. The computer-implemented method of claim 1, wherein the current stock information for the multiple ingredients includes first stock information for a first ingredient of the multiple ingredients and second stock information for a second ingredient of the multiple ingredients, and wherein the first ingredient and the second ingredient are stocked by different business entities, each business entity providing a portion of the current stock information.

8. The computer implemented method of claim 1, further comprising:
identifying an alternative product recipe associated with the identified at least one product recipe that includes the at least one out-of-stock ingredient, wherein the alternative product recipe does not include the at least one out-of-stock ingredient, and wherein identifying the alternative product recipe includes estimating a similarity between an alternative product associated with the alternative product recipe and the at least one particular product associated with the at least one product recipe; and
automatically enabling ordering of the alternative product associated with the alternative product recipe in place of the at least one particular product.

9. The computer-implemented method of claim 1, further comprising:
offering the multiple products associated with the multiple product recipes for sale via a mobile-ordering application; and
dynamically updating an interface of the mobile-ordering application in real time to indicate availability of the multiple products, wherein the dynamic updating includes automatically disabling the ordering of the at least one particular product associated with the identified at least one product recipe.

10. The computer-implemented method of claim 1, further comprising:
estimating future stock information for at least some ingredients of the multiple ingredients, wherein the current stock information is modified to reduce stock of the at least some ingredients by a first quantity based on sold products during a first time period, the first time period being between a time of the current stock information and a current time, and the current stock information is further modified to reduce stock of the at least some ingredients by a second quantity based on estimated future product sales during a second time period, the second time period being between the current time and a future time.

11. The computer-implemented method of claim 1:
wherein the current stock information is received via a first computing device on a first network,
wherein the at least one product recipe of the multiple product recipes that includes the at least one out-of-stock ingredient is identified by a cloud server after receiving the current stock information via the first computing device; and
wherein automatically disabling the ordering of the at least one particular product includes updating, by the cloud server, a display of a second computing device, the second computing device comprising a customer device.

12. A system to automatically disable product orders based on current ingredient stock information, the system comprising:
a first computing device associated with an entity offering multiple products;
a second computing device associated with a user; and
a cloud server configured to perform operations comprising:
accessing an ingredient database containing indications of multiple ingredients utilized for the multiple products;
generating a recipe database that includes a mapping between multiple product recipes for the multiple products and the multiple ingredients from the ingredient database, wherein the mapping identifies for each of the multiple product recipes corresponding ingredients of the multiple ingredients required to create a respective product of the multiple products;
receiving, from the first computing device, current stock information for the multiple ingredients, wherein the current stock information includes an indication of at least one of the multiple ingredients being out of stock;
identifying, using the mapping and the current stock information, at least one product recipe of the multiple product recipes that includes the at least one out-of-stock ingredient;
in response to identifying the at least one product recipe that includes the at least one out-of-stock ingredient, automatically disabling ordering of at least one particular product associated with the identified at least one product recipe; and
updating a display of the second computing device to indicate the automatic disabling of the ordering of the at least one particular product.

13. The system of claim 12, wherein the recipe database includes, for at least some of the multiple product recipes, ingredient units of measure and ingredient quantities.

14. The system of claim 12, wherein the multiple product recipes include a first class of recipes comprising base product recipes and a second class of recipes comprising modifier recipes for modifier products, wherein the modifier products are offered as an add-on to at least one base product, and wherein automatically disabling ordering of the at least one particular product includes disabling both a modifier product and a base product.

15. The system of claim 12, wherein the operations further comprise:
identifying an alternative product recipe associated with the identified at least one product recipe that includes the at least one out-of-stock ingredient, wherein the alternative product recipe does not include the at least one out-of-stock ingredient, and wherein identifying the alternative product recipe includes estimating a similarity between an alternative product associated with the alternative product recipe and the at least one particular product associated with the at least one product recipe; and
automatically enabling ordering of the alternative product associated with the alternative product recipe in place of the at least one particular product.

16. The system of claim 12, wherein the operations further comprise:
estimating future stock information for at least some ingredients of the multiple ingredients, wherein the current stock information is modified to reduce stock of the at least some ingredients by a first quantity based on sold products during a first time period, the first time period being between a time of the current stock information and a current time, and the current stock information is further modified to reduce stock of the at least some ingredients by a second quantity based on estimated future product sales during a second time period, the second time period being between the current time and a future time.

17. A method of updating a product order display based on ingredient stock information, the method comprising:
accessing a collection of product recipes for multiple products, the product recipes comprising listings of ingredients included in a product;
determining stock information for the ingredients;
estimating future stock information for the ingredients, wherein the future stock information is based on past product sales, projected product sales, or both past product sales and projected product sales;
determining product availability for the multiple products based on the determined stock information and the estimated future stock information; and
automatically updating a display of a user device based on the determined product availability, wherein ordering of at least one product of the multiple products is enabled or disabled based on the determined product availability.

18. The method of claim 17, wherein the collection of product recipes is stored in a database, the method further comprising generating the database.

19. The method of claim 17, wherein the determined stock information includes current stock information comprising an indication of at least one out-of-stock ingredient, wherein determining the product availability includes identifying a product recipe that includes the at least one out-of-stock ingredient, and wherein automatically updating the display of the user device includes disabling ordering of a product associated with the identified product recipe.

20. The method of claim 17, wherein automatically updating the display of the user device includes enabling ordering of a product that is determined to be available based on the determined stock information and the estimated future stock information.
